(19) United States
(12) Patent Application Publication
(10) Pub. No.: US 2009/0050561 A1
(43) Pub. Date: Feb. 26, 2009

(54) SYSTEM AND METHOD FOR PROCESSING WASTEWATER

(76) Inventor: Jon Inman Sattler, Los Angeles, CA (US)

Correspondence Address: Woods Oviatt Gilman LLP, 700 Crossroads Bldg, 2 State St., Rochester, NY, 14614, US

(21) Appl. No.: 12/194,910

(22) Filed: Aug. 20, 2008

Related U.S. Application Data
(60) Provisional application No. 60/965,391, filed on Aug. 20, 2007.

(51) Int. Cl. C02F 1/02; C02F 3/00; C02F 9/08

(52) U.S. Cl. 210/609; 210/180; 210/179; 210/138; 210/774; 210/702; 210/738; 210/631

(57) ABSTRACT

A system and method for processing wastewater into usable water is provided. The method comprises: receiving a supply of wastewater; passing the wastewater into a refractory vessel having a heat generator associated therewith; increasing the temperature of the wastewater to a predetermined temperature using the heat generator for a predetermined amount of time to produce heated exhaust gases containing at least one product gas and water vapor; separating the at least one product gas and water vapor; and condensing the water vapor to produce usable water. The system comprises a refractory vessel defining a heat processing zone, a heat generator that is used to increase the temperature of the wastewater to produce a heated exhaust gas containing at least one product gas and water vapor, a scrubber to separate the product gases and the water vapor, and a condenser to condense the water vapor into usable water.

### CROSS-REFERENCE TO RELATED APPLICATIONS

This application claims the benefit of U.S. Provisional Patent Application No. 60/965,391, filed on Aug. 20, 2007, which is incorporated herein by reference in its entirety.

### FIELD OF THE INVENTION

The present patent application is directed to a system and method for processing wastewater. More particularly, the present patent application relates to the processing of wastewater using a heat generator, such as a plasma generator, to produce a supply of usable water.

### BACKGROUND OF THE INVENTION

Wastewater has a high pure water content, but requires substantial processing before it can be usable water because it typically contains human waste and other harmful contaminants, such as, for example, hazardous heavy metals, organic poisons, microbiological infective organisms, pharmaceuticals, medications and hormones. Currently, there are a variety of systems used in the treatment of wastewater. Some large municipal applications provide an integrated process of filters, oxygenators, settling tanks, clarifying tanks and digesters. In addition, some processes use ultraviolet (UV) light for destroying estrogens and hair products, chemical additives, carbon filtration to control odor, micropore filters with multiple barriers to decrease the dangers of infection, and ozone for color removal to achieve pureness and to add clarity to the water. These treatment processes generally comprise a biological format, using microorganisms contained in an active biomass for the removal of biological oxygen demand (bod, organic carbon compounds) and chemical oxygen demand (cod), phosphorous and or nitrogen from wastewater.

Furthermore, current wastewater systems may use multiple levels of treatment incorporating the processes described above, including, for example, preliminary treatment, primary treatment, and secondary treatment processes. While the existing treatment systems may produce usable water, it can be a long and rather complicated process for purifying a supply of wastewater. One of the major issues that has to be dealt with in wastewater treatment is the public discomfort of turning wastewater into drinking water.

The use of heat to achieve gasification of solid waste materials has been used for many years. Many sources of heat have been used, including fossil fuels, optic treatment of solar energy, electric energy and plasma generators. The use of a plasma generator for the disposal of municipal solid waste (refuse, garbage and, although there is no data available, it has been suggested that in Japan, solid waste residual) has been accomplished. Currently there are two successful plants operating in Japan, and construction of new plants in Canada and St. Lucie, Fla. are underway. Several other plants are under discussion in the United States. Generally speaking, municipal solid waste systems are comprised of a plasma generator as the gasification tool and a myriad of processes to achieve the disposal, including: the feed of solid waste, maintenance of waste temperature (e.g., Joule Bath), the removal of gases from the volatile materials, as well as the reduction of non-combustibles (e.g., glass and metal) to inert slag which is drained and disposed of. The resultant hot gases may then drive appropriate energy conversion means such as a turbine generator and may be scrubbed or otherwise purified before being allocated for further use or released to the atmosphere. Some patents refer to the introduction of liquid waste in the system. This generally refers to specific waste associated with carbon fuels, or other hazardous liquid manufactured products.

The disposal of waste materials, especially toxic wastes, with plasma generators is known. In such a process, a plasma generator transfers electrical energy through a stream of ionized gases so that the gases become an electrical conductor. A plasma generator disposal reactor raises the temperature of waste materials, including toxic waste materials, to such high levels that such materials break down chemically and decompose. This breakdown can be enhanced by maintaining an atmosphere of additive products in the processing chamber. As a result, the residues are usually harmless gases and solids which are suitably removed from the processing chamber. While the use of plasma generators for disposing of municipal solid waste is known, the use of plasma generators to process wastewater into usable water in the manner disclosed herein is not disclosed in the existing art.

The hallmark of the wastewater treatment using biological/mechanical processes is that they generally are very complex and require a lot of time and energy to isolate usable water from the contents of the wastewater.

Therefore, what is needed is a simplified and efficient system and method for producing usable water from wastewater that simplify the complex systems currently being used to process wastewater. The present invention meets this need as well as other needs.

### SUMMARY OF THE INVENTION

In order to address the need for efficiently providing usable water and to address the drawbacks of the existing methods for the treatment of wastewater, a method and system for processing wastewater from an available source is provided.

According to a first aspect of the present invention, a system and method for generating a supply of usable water is disclosed. In particular, the method comprises the steps of: a) receiving a supply of wastewater; b) passing the wastewater into a heat processing zone defined in a refractory vessel, wherein the refractory vessel has a heat generator, such as a plasma generator, associated therewith; c) increasing the temperature of the wastewater to a predetermined temperature using the heat generator for a predetermined amount of time to produce heated exhaust gases, wherein the heated exhaust gases includes at least one product gas and water vapor; d) separating the at least one product gas and water vapor; and e) condensing the water vapor to produce usable water. It will be understood that the method may include treating all or a portion of the wastewater in at least one of a pretreatment phase and a primary treatment phase to produce an effluent, wherein the effluent is processed into usable water using steps b) through e) recited above.

The method may also include mixing the wastewater upon entering the refractory vessel and keeping the wastewater in motion as the heat generator increases the temperature of the wastewater to the predetermined temperature. Further, a secondary treatment phase may include aeration and clarification of wastewater fed from the primary treatment phase, or, in the alternative, passing the wastewater from the primary treatment phase through a membrane bioreactor. The municipal solid waste produced in the membrane bioreactor may be processed in a solid waste plasma generator and/or an independent plasma generator refractory vessel.

Other aspects of the method recited above are also provided. For example, the method may include the steps of providing a gas turbine downstream of the refractory vessel and passing the heated exhaust gases through the gas turbine to produce electricity. The method may also comprise the steps of providing a steam turbine, creating heat with the separated at least one product gas, using the heat to generate steam from the usable water, and passing the steam through the steam turbine to produce electricity. The steam exhausted from the steam turbine may be used to preheat the wastewater passing into the refractory vessel.

A further aspect of the method recited above may include the steps of providing a heat exchanger downstream of the refractory vessel, wherein the heat exchanger includes a first side and a second side, providing a steam turbine, passing the heated exhaust gas through the first side of the heat exchanger, passing the usable water through the second side of the heat exchanger, wherein sufficient heat is transferred from the heated exhaust gas to the useable water in the heat exchanger to convert the usable water to steam, and passing the steam through the steam turbine to produce electricity. The steam exhausted from the steam turbine may be used to preheat the wastewater passing into the refractory vessel.

The system for processing wastewater into usable water disclosed herein includes a refractory vessel, a heat generator, a scrubber, and a condenser. The refractory vessel includes a heat processing zone therein for receiving a supply of wastewater. The heat generator, such as a plasma generator, is associated with the refractory vessel to increase the temperature of the wastewater within the heat processing zone to a predetermined temperature for a predetermined amount of time to produce a heated exhaust gas, wherein the heated exhaust gas includes at least one product gas and water vapor. The scrubber is used to separate the at least one product gas and the water vapor, and the condenser operates to condense the water vapor into usable water. The system may further include at least one of a pretreatment phase and a primary treatment phase, wherein all or a portion of the wastewater is fed through at least one of the phases to produce an effluent, wherein the effluent is fed to the refractory vessel to produce usable water.

The system may also include at least one mixer for mixing the effluent upon entering the refractory vessel, and including at least one mixing apparatus, for example, at least one paddle, for keeping the effluent in motion as the heat generator increases the temperature of the effluent to the predetermined temperature. A secondary treatment phase may include an aerator and a clarification tank, or, in the alternative, a membrane bioreactor to produce a secondary effluent. In the instance that the secondary treatment phase utilizes a membrane bioreactor, the municipal solid waste that is produced by the membrane bioreactor may be fed to a solid waste plasma generator and/or an independent plasma generator refractory vessel.

In another aspect of the system set forth above, the system may include a gas turbine disposed downstream of the refractory vessel, wherein the heated exhaust gas is passed through the gas turbine to produce electricity.

In yet another aspect of the system set forth above, the system may include a steam turbine and a gas flame heater, wherein the separated at least one product gas is burned in the gas flame heater to produce heat, the usable water is fed into the gas flame heater to generate steam, and wherein the steam is fed through the steam turbine to produce electricity.

In a further aspect, the system may include a heat exchanger disposed downstream of the refractory vessel, and a steam turbine. The heat exchanger includes a first side and a second side. The heated exhaust gas is passed through the first side of the heat exchanger and the usable water is passed through the second side of the heat exchanger, wherein sufficient heat is transferred from the heated exhaust gas to the useable water to convert the usable water to steam. The steam is then passed through the steam turbine to produce electricity.

In yet another aspect of the present invention, there may be great advantage to the co-utilization of a municipal solid waste plasma furnace or independent plasma generator refractory vessel for the gasification of waste (primary sludge) from a primary treatment phase or secondary treatment phase. In addition, the fats, oil and grease (FOG) resulting from the primary treatment can be used as fuel for further reclamation of energy.

As mentioned above, wastewater can contain human waste and other harmful contaminants. Current techniques use a multiplicity of systems and methods to get usable water from this array of contaminants. The method and system presented herein provides the ultimate desired result of usable water, free of these contaminants, in an efficient manner using only plasma processing, a scrubber and a condenser. In addition, it provides the possibility of recovering some of the energy required to process the wastewater.

### BRIEF DESCRIPTION OF THE DRAWINGS

The above-mentioned and other features and advantages of this invention, and the manner of attaining them, will become apparent and be better understood by reference to the following description of the aspects of the invention in conjunction with the accompanying drawings, wherein:

FIG. 1 is a schematic drawing of a wastewater treatment system including a refractory vessel in accordance with a first aspect of the present invention;

FIG. 2 is a schematic drawing of the refractory vessel shown in FIG. 1;

FIG. 3 is a schematic drawing of other aspects of the present invention; and

FIG. 4 is a schematic drawing of another version of the wastewater treatment system shown in FIG. 1.

Additional aspects, advantages, and novel features in the invention will be set forth in part in the description that follows, and in part will become apparent to those in the practice area of the invention.

### DETAILED DESCRIPTION OF THE INVENTION

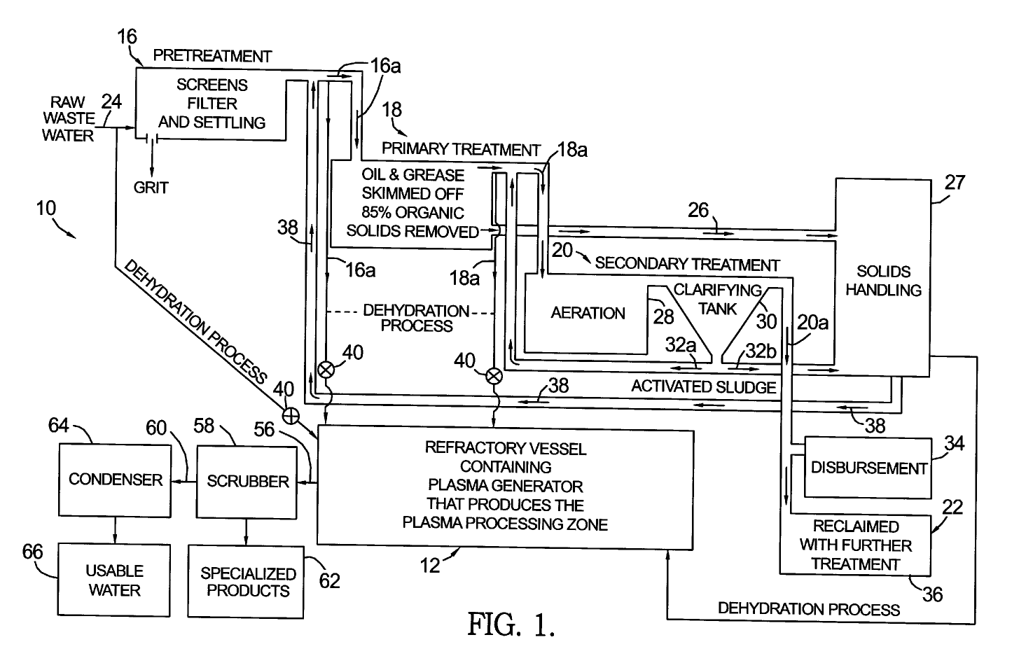

Referring to the drawings in detail, and particularly FIG. 1, a wastewater treatment system in accordance with a first aspect of the present invention is shown generally as reference numeral 10. In general, wastewater treatment system 10 in accordance with the present invention includes a refractory vessel 12 containing a heat generator 14, such as, for example, a plasma generator, that operates to increase the temperature of a supply of wastewater, or an effluent derived from the supply of wastewater, to a predetermined temperature for a predetermined amount of time to provide water that is usable for human consumption, agricultural and industrial use. The details of wastewater treatment system 10 are set forth below.

In the water treatment system 10 set forth in FIG. 1, the effluents 16a, 18a that may be fed to refractory vessel 12 are derived from wastewater that is processed in at least one of a pretreatment phase 16 and a primary treatment phase 18. In operation, the supply of wastewater 24 that is fed to the wastewater treatment system 10 may first enter pretreatment phase 16, wherein solid inorganic materials are removed from the wastewater using bar screens and sedimentation tanks 26 to capture sand, silt and other gritty solids. The pretreated effluent 16a produced from pretreatment phase 16 may include organic matter, including human waste, fats, oils, etc. with a dehydration process may be fed to refractory vessel 12.

In the primary treatment phase 18, approximately 85 percent of organic and inorganic suspended solids may be removed from pretreated effluent 16a to meet the requirement for obtaining National Pollutant Discharge Elimination System (NPDES) discharge permits. The suspended solids are precipitated out of pretreated effluent 16a using coagulants and about 1-2 hours of sedimentation. The solids 26 (i.e., primary sludge) settle to the bottom of the tanks and the fats, oil and grease (FOG) float to the surface and are skimmed off the top of the wastewater. The primary sludge 26 may then be pumped to a solid waste residual handling unit 27, including one or more anaerobic digesters, for further processing. The dehydrated solid waste residual can then be treated with either a municipal solid waste plasma generator or an independent plasma generator refractory vessel. The remaining water, which is referred to as primary effluent 18a with a dehydration process, may be fed to refractory vessel 12 and/or to secondary treatment phase 20 for further treatment.

The secondary treatment phase 18 typically involves the use of living microorganisms, referred to as activated sludge, to remove remaining nutrients or non-settling suspended and soluble organics from primary effluent 18a. Initially, activated sludge may be mixed with primary effluent 18a, and then the mixture is fed into an aeration tank 28. After sufficient retention time in aeration tank 28, the mixture of primary effluent 18a and activated sludge is introduced into a clarifying or settling tank 30 wherein the biomass separates as settled activated sludge 32 from the primary effluent 18a to produce secondary effluent 20a. This process may take hours and results in the removal of about 90 to 95 percent of the solids in the primary effluent 18a. All or a part of activated sludge 32a may then be mixed with the primary effluent 18a prior to being introduced into aeration tank 28 (i.e., return activated sludge) or be fed to solid handling unit 27 for further processing, which is represented by reference numeral 32b. After the completion of secondary treatment phase 20, secondary effluent 20a may be fed to a disbursement system 34 wherein secondary effluent 20a is pumped out to sea or stored in large underground storage areas, and/or fed to a reclamation system 36 with further treatment to be used for municipal purposes, such as watering golf courses, parks and vehicle washing, or industrial purposes.

The primary sludge 26 and activated sludge 32b (collectively referred to herein as solid waste residuals) referred to above may be fed to solids handling unit 27, wherein the solid waste residuals are handled in digesters to harvest methane gas and in centrifuges to yield biosolids that can be used for agricultural purposes. Furthermore, the solid waste residuals may also be redistributed through a return feed 38 and mixed with pretreated effluent 16a prior to entering the primary treatment phase 18 or after a digestion/dehydration process solid waste residual (27) may be treated in a municipal solid waste plasma generator or an independent plasma generator refractory vessel.

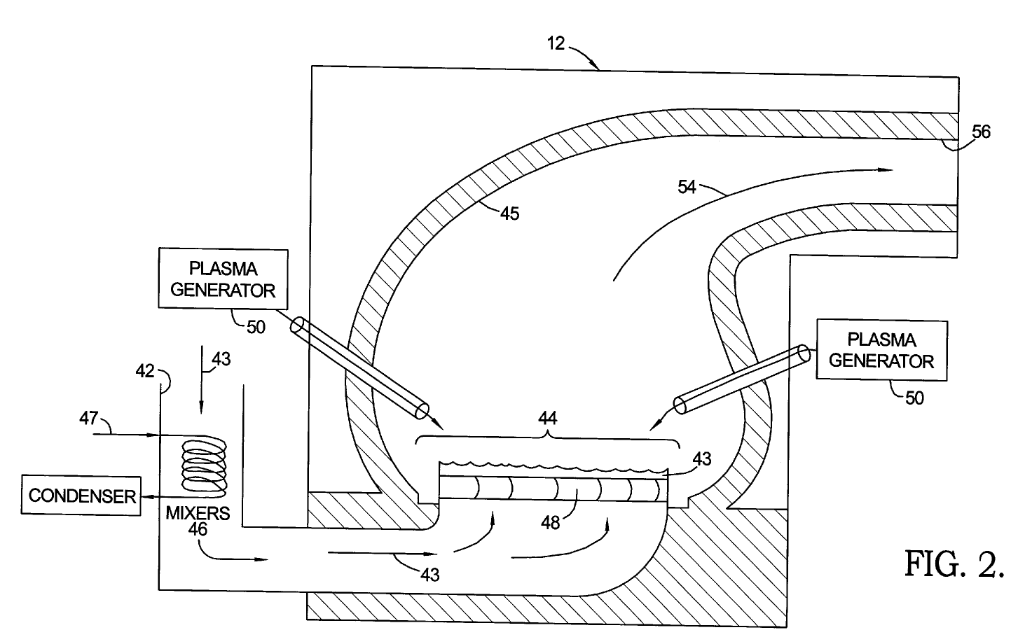

In accordance with one aspect of the present invention, the supply of raw wastewater (sewage) 24 and/or one or more of the effluents 16a, 18a may be controllably fed to refractory vessel 12 to produce usable water. The conduits that direct the incoming wastewater and/or one or more of the effluents 16a, 18a into refractory vessel may have a regulating device 40 associated therewith to controllably regulate the flow of wastewater and/or effluent into a plasma processing zone 26 (FIG. 2) contained within refractory vessel 12. Instead of including separate regulating devices for each effluent feed, it will be understood that there may be a single effluent feed into the refractory vessel 12 that is downstream from feeds 16a, 18a to allow for a single regulating device that controls the effluent entering refractory vessel 12. It will also be understood that if effluent feed to the refractory vessel 12 is derived from raw wastewater 24, some initial screening, filtration steps, and dehydration steps may be required.

One example of refractory-lined vessel 12 that may be used in wastewater system 10 described herein is shown in FIG. 2. Refractory vessel 12 includes an intake port 42 for feeding wastewater 24 and/or effluent 16a, 18a (collectively referred to herein as refractory intake effluent 43) to a high temperature plasma processing zone 44 (i.e., heat processing zone) that is defined within a chamber 45 of refractory vessel 12. Upon flowing through intake port 42, refractory intake effluent 43 may flow into one or more mixers 46. The mixers 46 are used to achieve a homogeneous fluid, to add steam heat 47 or other additives, as needed and assist in maintaining a constant flow of effluent through intake port 42 to plasma processing zone 44. Further, the refractory intake effluent 43 is modulated by at least one mixing apparatus 48 to keep refractory intake effluent 43 in motion for an even exposure to the plasma processing zone 44, thereby forming a layer of refractory intake effluent 43 with a relatively large surface area that can be quickly heated to the desired high temperature. One aspect of this wastewater system 10 contemplates a flow regulating device (not shown) to assure that all refractory intake effluent 43 reaches a sufficiently high predetermined temperature, for a sufficient predetermined amount of time, to fully process refractory intake effluent 43 to fundamental atoms and molecules in a gas form.

Further, the refractory vessel 12 includes at least one heat generator 50, such as a cost effective AC plasma generator, fossil fuels, optic treatment of solar energy and electric energy, that operates to raise and maintain the temperature within plasma processing zone 44 at very high temperatures in thousands of degrees centigrade. The energy source to drive the plasma generators is derived from an electrical source. It will also be understood that refractory vessel 12 may include inlet ports (not shown) for feeding air and/or additive agents to the high temperature plasma processing zone 44. Upon heating refractory intake effluent 43 within plasma processing zone 44 within a predetermined temperature range for a predetermined amount of time, heated exhaust gases 54 are produced that fill chamber 45 and escape through a narrowing outlet 56 of refractory vessel 12. The heated exhaust gases 54 may include a mixture of one or more product gases and water vapor. It should be understood that the contents of the heated exhaust gases will vary according to the effluent and additives introduced into refractory vessel 12.

As best seen in FIG. 1, after the heated exhaust gases 54 are emitted from outlet 56 of refractor vessel 12, they are introduced to a scrubber 58 that operates to separate heated exhaust gases 54 into water vapor 60 and one or more product gases 62. The water vapor 60 is then fed to a condenser 64 that operates to condense the water vapor to usable water 66 for at least one of human consumption, agricultural use and industrial use. In addition, any sludge that is contained within wastewater 24 and/or one or more of the effluents 16a, 18a that is fed to refractory vessel 12 will be treated by refractory vessel 12 and thereby eliminate a substantial portion of the sludge that is collected and processed by solids handling unit 27.

It should be understood that the plasma generator may have different requirements for processing the intake effluent into usable water depending on the type of effluent is fed to the plasma generator. For example, primary treatment phase operates to isolate fats, oils and grease (FOG) from the water and precipitated or settled material. The precipitated or settled material (i.e., primary sludge) with a dehydration process may also be treated by the plasma generator, eliminating the arduous tasks of sludge treatment using, grinders, compactors, driers, and digesters. Further, the primary effluent may go on to the secondary treatment phase where, rather than have activated microorganisms digest the residual organic material, the primary effluent feed with a dehydration process may go to the plasma generator that gasifies the primary effluent, the resultant heated exhaust gas is scrubbed removing the specialized product gases and releasing the water to be condensed.

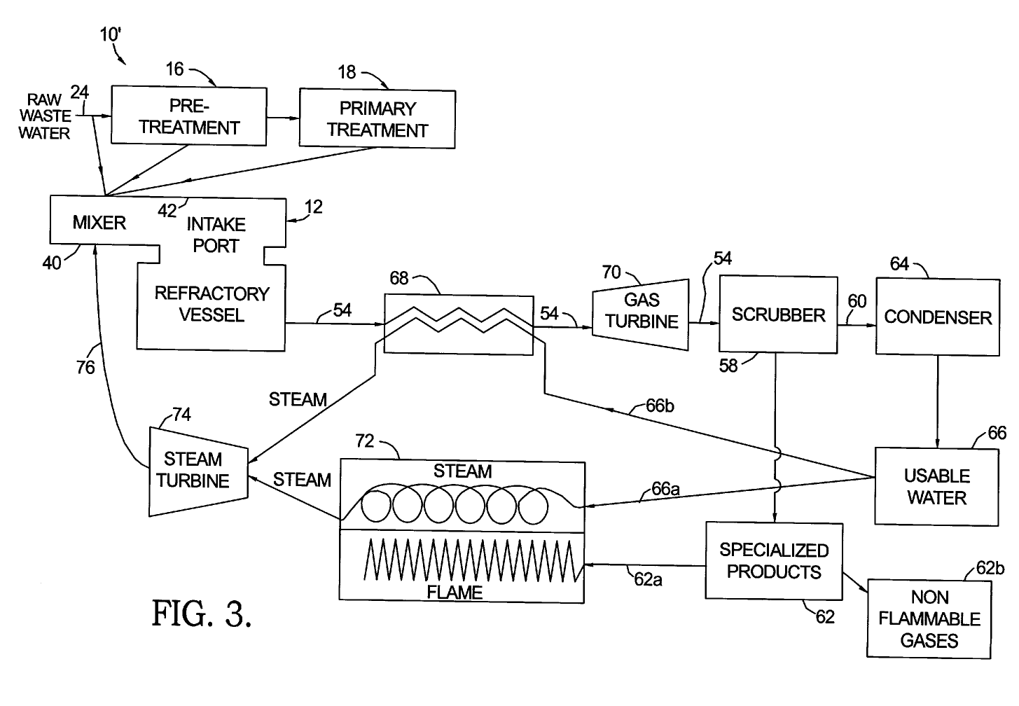

A second aspect of the present invention relates to a wastewater processing system 10′ shown in FIG. 3, which operates to generate electricity using the heated exhaust gases 54 emitted from refractory vessel 12, the usable water condensed in the condenser 64, and the specialized product gases 62 separated by scrubber 58. The components described with respect to wastewater processing system 10 also is applicable to the system 10′ shown in FIG. 3. However, the wastewater system 10′ shown and described in FIG. 3 includes additional components that were not included in system 10. In particular, the heated exhaust gases 54 that are emitted from outlet 56 of refractory vessel 12 may pass through a first side of a heat exchanger 68 and then through a gas turbine 70 to generate electricity. The exhaust gas 54 coming out of gas turbine 70 is passed through scrubber 58, wherein the resultant products are separated into specialized product gases 62 and water vapor 60. The water vapor 60 coming out of scrubber 58 is sent to condenser 64 for the distillation of usable water 66. Some of specialized products 62 may be able to be modified to have a flammable quality. The flammable specialized products 62a can be used in a gas flame heater 72 to bring water 66a that was distilled from condenser 64 to a superheated state, which expands through a steam turbine 74 to produce electric energy. As best seen in FIG. 3, the exhaust 76 of the steam turbine 74 can be mixed with refractory intake effluent 43 entering the refractory vessel 12, which could make up all or part of the supply of steam 47 shown in FIG. 2. In the alternative, the specialized products 62b can be stored for further treatment and sales.

In a third aspect of the wastewater processing system 10′, as best seen in FIG. 3, heated exhaust gases 54 passing through the first side of heat exchanger 68 may be used in a steam cycle to produce electrical energy using steam turbine 74. In particular, the heated exhaust gases 54 passing through the first side of heat exchanger 68 operate to transfer heat to water 66b passing through a second side of heat exchanger 68 that is pumped from the usable water 66 distilled from condenser 64. The water 66b gains a sufficient amount of heat from exhaust gas 54 to convert water 66b to steam to drive steam turbine 74 and thereby generate electricity.

A fourth embodiment (not shown) considers the possibility of other architectural and engineering possibilities for the design of refractory vessel. The refractory vessel may appear to be but not limited to a tube-like structure, curved at one end and a narrowed outlet at the other. A wastewater feed is located at the curved end of the device. This feed has a regulating device that controls the flow of wastewater into the plasma processing zone. The wastewater cascades down over the surface of a series of steps allowing its exposure to the plasma processing zone. The plasma processing zone has very high temperatures that can be thousands of degrees centigrade produced by the plasma generator. The wastewater is processed in the plasma processing zone. The resultant heated gas escapes through the narrowing in the far end of the refractory vessel.

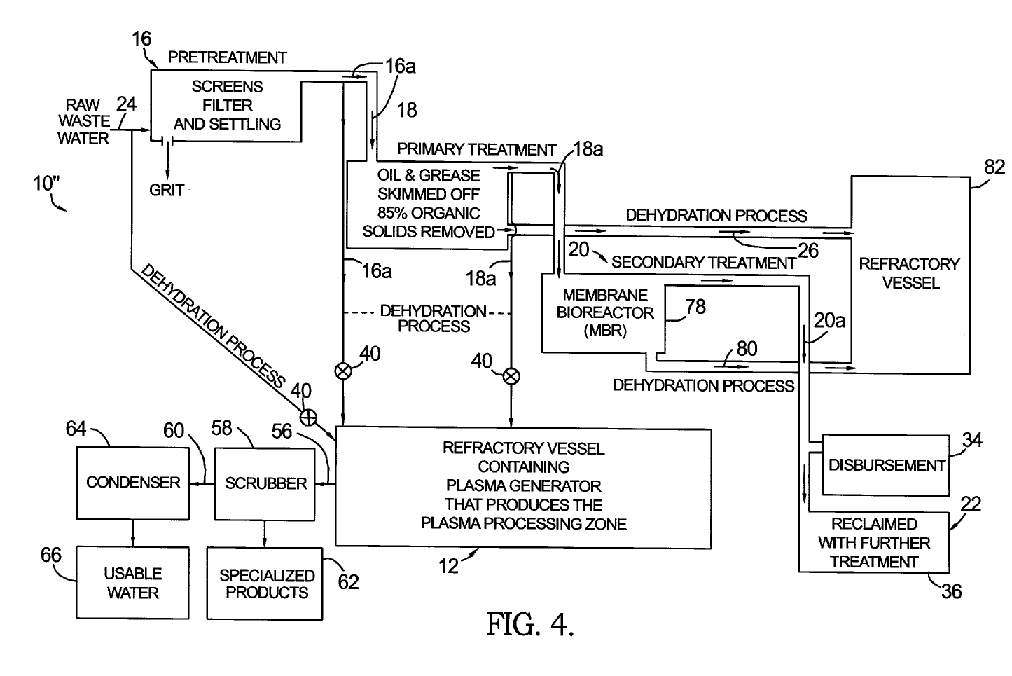

As best seen in FIG. 4, a fifth aspect of the wastewater treatment system is provided and is generally indicated with reference numeral 10″. The wastewater treatment system 10″ is similar in many respects to the system 10 shown in FIG. 1, except the aeration tank 28 and clarifying tank 30 are replaced with a membrane bioreactor (MBR) 78 that combines primary effluent with a membrane liquid-solid separation process. The membrane component uses low pressure microfiltration or ultrafiltration membranes may eliminate the need for clarification and tertiary filtration. However, secondary effluent 20a may still contain organisms, dissolved particles causing decreased clarity, pharmaceuticals, etc. and, if that is the case, these residuals may be handled using chlorine, ultraviolet (UV) light, ozone, carbon filters and other known treatment methods. Further, the mixed liquor or sludge 80 left over from the membrane bioreactor process may be disposed of with a dehydration process and a subsequent refractory vessel 82 either a municipal solid waste (MSW) plasma generator or an independent plasma generator refractory vessel thereby eliminating the need for the solids handling 27 (solid waste residual) shown in FIG. 1.

While the invention has been described by reference to various specific aspects, it should be understood that numerous changes may be made within the spirit and scope of the inventive concepts described. Accordingly, it is intended that the invention not be limited to the described aspects, but will have full scope defined by the language of the following claims.

I claim:

1. A method of processing wastewater into usable water, the method comprising:
a) receiving a supply of wastewater;
b) passing the wastewater into a refractory vessel, the refractory vessel having a heat generator associated therewith;
c) increasing the temperature of the wastewater to a predetermined temperature using the heat generator for a predetermined amount of time to produce heated exhaust gases, wherein the heated exhaust gases include at least one product gas and water vapor;
d) separating the at least one product gas and water vapor; and
e) condensing the water vapor to produce usable water.

2. A method of processing wastewater as recited in claim 1, wherein the heat generator is a plasma generator.

3. A method of processing wastewater as recited in claim 1, wherein the refractory vessel defines a heat processing zone, wherein the wastewater is exposed to the heat processing zone, and wherein the heat generator increases the temperature of the wastewater to the predetermined temperature within the heat processing zone to produce the heated exhaust gases.

4. A method of processing wastewater as recited in claim 1, further comprising the step of treating at least a portion of the wastewater in at least one of a pretreatment phase and a primary treatment phase to produce an effluent, wherein the effluent is processed into usable water using steps b) through e).

5. A method of processing wastewater as recited in claim 4, wherein all of the wastewater is treated in at least one of a pretreatment phase and a primary treatment phase prior to being passed into the refractory vessel, wherein only the effluent resulting from the at least one phase is passed into the refractory vessel.

6. A method of processing wastewater as recited in claim 5, further comprising the step of mixing the effluent upon entering the refractory vessel.

7. A method of processing wastewater as recited in claim 5, further comprising the step of keeping the effluent in motion as the heat generator increases the temperature of the effluent to the predetermined temperature.

8. A method of processing wastewater as recited in claim 4, further comprising a secondary treatment phase including aeration and clarification of effluent fed from the primary treatment phase.

9. A method of processing wastewater as recited in claim 4, further comprising a secondary treatment phase including passing effluent from the primary treatment phase through a membrane bioreactor.

10. A method of processing wastewater as recited in claim 9, wherein passing the effluent from the primary treatment phase through the membrane bioreactor produces sludge, and further comprising the step of processing the sludge with a dehydration process in at least one of a solid waste plasma generator and an independent plasma generator refractory vessel.

11. A method of processing wastewater as recited in claim 1, wherein the at least one product gas and water vapor are separated using a scrubber.

12. A method of processing wastewater as recited in claim 1, further comprising the steps of:
providing a gas turbine downstream of the refractory vessel; and
passing the heated exhaust gases through the gas turbine to produce electricity.

13. A method of processing wastewater as recited in claim 1, further comprising the steps of:
providing a steam turbine;
creating heat with the separated at least one product gas;
using the heat to generate steam from the usable water; and
passing the steam through the steam turbine to produce electricity.

14. A method of processing wastewater as recited in claim 13, further comprising the step of using the steam exhausted from the steam turbine to increase the temperature of the wastewater passing into the refractory vessel.

15. A method of processing wastewater as recited in claim 1, further comprising the steps of:
providing a heat exchanger downstream of the refractory vessel, the heat exchanger including a first side and a second side;
providing a steam turbine;
passing the heated exhaust gas through the first side of the heat exchanger;
passing the usable water through the second side of the heat exchanger, wherein sufficient heat is transferred from the heated exhaust gas to the useable water in the heat exchanger to convert the usable water to steam; and
passing the steam through the steam turbine to produce electricity.

16. A method of processing wastewater as recited in claim 15, further comprising the step of using the steam exhausted from the steam turbine to heat the wastewater passing into the refractory vessel.

17. A system for processing wastewater into usable water, comprising:
a refractory vessel defining a heat processing zone therein for receiving a supply of wastewater;
a heat generator associated with the refractory vessel to increase the temperature of the wastewater within the heat processing zone to a predetermined temperature for a predetermined amount of time to produce a heated exhaust gas, wherein the heated exhaust gas includes at least one product gas and water vapor;
a scrubber to separate the at least one product gas and the water vapor; and
a condenser to condense the water vapor into usable water.

18. A system for processing wastewater as recited in claim 17, wherein the heat generator is a plasma generator.

19. A system for processing wastewater as recited in claim 17, further comprising at least one of a pretreatment phase and a primary treatment phase, wherein at least a portion of the wastewater is fed through at least one of the phases to produce an effluent, wherein the effluent is fed to the refractory vessel to produce usable water.

20. A system for processing wastewater as recited in claim 17, further comprising at least one of a pretreatment phase and a primary treatment phase, wherein all of the wastewater is fed through at least one of the phases to produce an effluent, wherein the effluent is fed to the refractory vessel to produce usable water.

21. A system for processing wastewater as recited in claim 20, further comprising at least one mixer for mixing the effluent upon entering the refractory vessel.

22. A system for processing wastewater as recited in claim 20, further comprising at least one mixing apparatus for keeping the effluent in motion as the heat generator increases the temperature of the effluent to the predetermined temperature.

23. A system for processing wastewater as recited in claim 19, further comprising a secondary treatment phase including an aerator and a clarification tank.

24. A system for processing wastewater as recited in claim 19, further comprising a secondary treatment phase including a membrane bioreactor.

25. A system for processing wastewater as recited in claim 24, further comprising one of a solid waste plasma generator or an independent plasma generator refractory vessel that is fed municipal solid waste produced by the membrane bioreactor.

26. A system for processing wastewater as recited in claim 17, further comprising a gas turbine downstream of the refractory vessel, wherein the heated exhaust gas is passed through the gas turbine to produce electricity.

27. A system for processing wastewater as recited in claim 17, further comprising a steam turbine and a gas flame heater, wherein the separated at least one product gas is burned in the gas flame heater to produce heat, the usable water is fed into the gas flame heater to generate steam, and wherein the steam is fed through the steam turbine to produce electricity.

28. A system for processing wastewater as recited in claim 17, further comprising:
a heat exchanger downstream of the refractory vessel, the heat exchanger including a first side and a second side; and
a steam turbine, wherein the heated exhaust gas is passed through the first side of the heat exchanger, wherein the usable water is passed through the second side of the heat exchanger so that sufficient heat is transferred from the heated exhaust gas to the useable water to convert the usable water to steam, and wherein the steam is passed through the steam turbine to produce electricity.
